(19) United States
(12) Patent Application Publication
(10) Pub. No.: US 2021/0110408 A1
(43) Pub. Date: Apr. 15, 2021

(54) SYSTEMS AND METHODS FOR IDENTIFYING A DAMAGED VEHICLE IN AN ONLINE TO OFFLINE SERVICE

(71) Applicant: BEIJING DIDI INFINITY TECHNOLOGY AND DEVELOPMENT CO., LTD., Beijing (CN)

(72) Inventor: Licai QI, Hangzhou (CN)

(73) Assignee: BEIJING DIDI INFINITY TECHNOLOGY AND DEVELOPMENT CO., LTD., Beijing (CN)

(21) Appl. No.: 17/131,780

(22) Filed: Dec. 23, 2020

Related U.S. Application Data
(63) Continuation of application No. PCT/CN2018/120324, filed on Dec. 11, 2018.

(30) Foreign Application Priority Data
Dec. 6, 2018 (CN) 201811488628.5

(51) Int. Cl. G06Q 30/00; G06Q 30/02; G06Q 10/00; G07C 5/08

(52) U.S. Cl. CPC G06Q 30/0185; G07C 5/0808; G06Q 10/20; G06Q 30/0208

(57) ABSTRACT

A method for identifying a damaged vehicle may include receiving a request for checking a vehicle. The method may also include obtaining feature values of a plurality of first determining features associated with the vehicle in response to the request. The method may also include determining whether the vehicle is damaged based on a first prediction model and the feature values of the first determining features. The first prediction model may be based on a plurality of historical vehicle damage reports including the first determining features. The method may also include transmitting first electronic signals to an electronic device. The first electronic signals may direct the electronic device to display one or more first messages related to whether the vehicle is damaged.

### CROSS-REFERENCE TO RELATED APPLICATIONS

This application is a continuation of International Application No. PCT/CN2018/120324, filed on Dec. 11, 2018, which claims priority to Chinese Patent Application No. 201811488628.5 filed on Dec. 6, 2018, the contents of each of which are incorporated herein by reference.

### TECHNICAL FIELD

The present disclosure generally relates to online to offline (O2O) services, and specifically, to systems and methods for identifying a false breakdown report for a vehicle and/or identifying damaged vehicles in an O2O service.

### BACKGROUND

With the development of Internet technology, O2O services, such as online on-demand or sharing services, play a more and more significant role in people's daily lives. Taking vehicle on demand service or sharing service as an example, in some occasions, the user wants to know whether the vehicle is damaged before the user starts to use the vehicle. In some other occasions, a user of an O2O service platform may submit a breakdown report for a vehicle to the O2O service platform during or before the user operates the vehicle. Preferably, the O2O service platform needs to identify damaged vehicles before it is being used. In some cases, the O2O service platform needs to determine whether the breakdown report is true or false before further processing can be started. Therefore, it is desirable to provide systems and methods for identifying a false breakdown report for a vehicle to avoid potential malicious breakdown reports, and/or systems and methods for identifying damaged vehicles in the O2O service platform to improve user experience of the O2O service platform.

### SUMMARY

According to one aspect of the present disclosure, a system for identifying a false breakdown report for a vehicle in an online to offline service may include at least one storage medium including a set of instructions, and at least one processor in communication with the at least one storage medium. When executing the set of instructions, the at least one processor may receive a breakdown report for a vehicle from a user. The at least one processor may also obtain feature values of a plurality of determining features associated with the user or the vehicle in response to the breakdown report. The at least one processor may also determine whether the breakdown report is false based on a prediction model and the features values. The prediction model may be based on a plurality of historical breakdown reports including the determining features. The at least one processor may also transmit electronic signals to a mobile device associated with the user. The electronic signals may direct the mobile device to display one or more messages related to whether the breakdown report is false.

In some embodiments, the breakdown report may include at least one vehicle image obtained by the user. To determine whether the breakdown report is false based on the prediction model and the feature values, the at least one processor may determine whether the vehicle image is corresponding to the vehicle. In response to a determination that the vehicle image is corresponding to the vehicle, the at least one processor may determine whether the vehicle in the vehicle image is damaged based on the prediction model; and determine whether the breakdown report is false based on a determination associated with whether the vehicle in the vehicle image is damaged.

In some embodiments, the breakdown report may be produced after the user tries to operate the vehicle. The determining features includes at least one of a time period the user operates the vehicle, a distance the user travels using the vehicle, a time point when the user starts to operate the vehicle, a number of times the vehicle is operated, a number of breakdown reports related to the vehicle, a time when the vehicle is put into use, information related to historical orders of the online to offline service, information related to completed orders of the historical orders, a total distance the user travels, a total number of historical breakdown reports transmitted by the user, a number of true breakdown reports of the historical breakdown reports, or a ratio between the true breakdown reports and the historical breakdown reports.

In some embodiments, the vehicle may be a bicycle.

In some embodiments, in response to a determination that the breakdown report is false, the electronic signals may further direct the mobile device to forbid the user to operate any vehicles related to the online to offline service.

In some embodiments, in response to a determination that the breakdown report is true, the one or more messages may further include one or more electronic coupons.

According to another aspect of the present disclosure, a method for identifying a false breakdown report for a vehicle in an online to offline service may include one or more of the following operations. The method may be implemented on a computing device having at least one storage device and at least one processor. The method may include receiving a breakdown report for a vehicle from a user. The method may also include obtaining feature values of a plurality of determining features associated with the user or the vehicle in response to the breakdown report. The method may also include determining whether the breakdown report is false based on a prediction model and the features values. The prediction model may be based on a plurality of historical breakdown reports including the determining features. The method may also include transmitting electronic signals to a mobile device associated with the user. The electronic signals may direct the mobile device to display one or more messages related to whether the breakdown report is false.

According to yet another aspect of the present disclosure, a system for identifying a false breakdown report for a vehicle in an online to offline service may include an obtaining module, a determination module and a transmission module. The obtaining module may be configured to receive a breakdown report for a vehicle from a user. The obtaining module may also be configured to obtain feature values of a plurality of determining features associated with the user or the vehicle in response to the breakdown report. The determination module may be configured to determine whether the breakdown report is false based on a prediction model and the features values. The prediction model may be based on a plurality of historical breakdown reports including the determining features. The transmission module may be configured to transmit electronic signals to a mobile device associated with the user, wherein the electronic signals direct the mobile device to display one or more messages related to whether the breakdown report is false.

According to yet another aspect of the present disclosure, a non-transitory readable medium may include at least one set of instructions for identifying a false breakdown report for a vehicle in an online to offline service. The at least one set of instructions may be executed by one or more processors of a computing device. The one or more processors may receive a breakdown report for a vehicle from a user. The one or more processors may also obtain feature values of a plurality of determining features associated with the user or the vehicle in response to the breakdown report. The one or more processors may also determine whether the breakdown report is false based on a prediction model and the features values. The prediction model may be based on a plurality of historical breakdown reports including the determining features. The one or more processors may also transmit electronic signals to a mobile device associated with the user. The electronic signals may direct the mobile device to display one or more messages related to whether the breakdown report is false.

According to yet another aspect of the present disclosure, a system for identifying a damaged vehicle may include at least one storage medium including a set of instructions, and at least one processor in communication with the at least one storage medium. When executing the set of instructions, the at least one processor may receive a request for checking a vehicle. The at least one processor may also obtain feature values of a plurality of first determining features associated with the vehicle in response to the request. The at least one processor may also determine whether the vehicle is damaged based on a first prediction model and the feature values of the first determining features. The first prediction model may be based on a plurality of historical vehicle damage reports including the first determining features. The at least one processor may transmit first electronic signals to an electronic device. The first electronic signals may direct the electronic device to display one or more first messages related to whether the vehicle is damaged.

In some embodiments, to receive the request for checking the vehicle, the at least one processor may receive a request for opening a lock of the vehicle from a first user.

In some embodiments, to receive the request for checking the vehicle, the at least one processor may determine that a first user intends to initiate an order associated with an online to offline service, wherein the vehicle may be within a predetermined distance from a location of the first user.

In some embodiments, the electronic device may be associated with the first user or a maintenance worker.

In some embodiments, the first determining features associated with the vehicle may include breakdown reports associated with the vehicle received from second users. In response to a determination that the vehicle is damaged, the at least one processor may determine one or more damaged components of the vehicle based on the breakdown reports. The at least one processor may transmit second electronic signals to the electronic device, directing the electronic device to display one or more second messages indicating the one or more damaged components of the vehicle.

In some embodiments, to receive the request for checking the vehicle, the at least one processor may receive a breakdown report for the vehicle from a second user. The at least one processor may determine that the breakdown report is true.

In some embodiments, to determine that the breakdown report is true, the at least one processor may obtain feature values of a plurality of second determining features associated with the second users or the vehicle. The at least one processor may determine whether the breakdown report is true based on a second prediction model and the features values of the second determining features, wherein the second prediction model is based on a plurality of historical breakdown reports including the second determining features.

In some embodiments, the breakdown report may include at least one vehicle image obtained by the second users. To determine whether the breakdown report is true based on the second prediction model and the feature values of the second determining features, the at least one processor may determine whether the at least one vehicle image is corresponding to the vehicle. In response to a determination that the at least one vehicle image is corresponding to the vehicle, the at least one processor may determine whether the vehicle in the at least one vehicle image is damaged based on the second prediction model. The at least one processor may determine whether the breakdown report is true based on a determination associated with whether the vehicle in the at least one vehicle image is damaged.

In some embodiments, the vehicle may be a bicycle.

According to yet another aspect of the present disclosure, a method for identifying a damaged vehicle may be implemented on a computing device having at least one storage device and at least one processor. The method may include receiving a request for checking a vehicle. The method may also include obtaining feature values of a plurality of first determining features associated with the vehicle in response to the request. The method may also include determining whether the vehicle is damaged based on a first prediction model and the feature values of the first determining features. The first prediction model may be based on a plurality of historical vehicle damage reports including the first determining features. The method may also include transmitting first electronic signals to an electronic device. The first electronic signals may direct the electronic device to display one or more first messages related to whether the vehicle is damaged.

According to yet another aspect of the present disclosure, system for identifying a damaged vehicle may include an obtaining module, a determination module and a transmission module. The obtaining module may be configured to receive a request for checking a vehicle. The obtaining module may also obtain feature values of a plurality of first determining features associated with the vehicle in response to the request. The determination module may be configured to determine whether the vehicle is damaged based on a first prediction model and the feature values of the first determining features. The first prediction model may be based on a plurality of historical vehicle damage reports including the first determining features. The transmission module may be configured to transmit first electronic signals to an electronic device. The first electronic signals may direct the electronic device to display one or more first messages related to whether the vehicle is damaged.

According to yet another aspect of the present disclosure, a non-transitory readable medium may include at least one set of instructions for identifying a damaged vehicle. The at least one set of instructions may be executed by one or more processors of a computing device. The one or more processors may receive a request for checking a vehicle. The one or more processors may also obtain feature values of a plurality of first determining features associated with the vehicle in response to the request. The one or more processors may also determine whether the vehicle is damaged based on a first prediction model and the feature values of the first determining features. The first prediction model may be based on a plurality of historical vehicle damage reports including the first determining features. The one or more processors may transmit first electronic signals to an electronic device. The first electronic signals may direct the electronic device to display one or more first messages related to whether the vehicle is damaged.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a schematic diagram illustrating an exemplary O2O service system according to some embodiments of the present disclosure;

FIG. 2 is a schematic diagram illustrating exemplary hardware and software components of a computing device on which a processing engine may be implemented according to some embodiments of the present disclosure;

FIG. 3 is a schematic diagram illustrating exemplary hardware and/or software components of a mobile device on which a terminal device may be implemented according to some embodiments of the present disclosure;

FIG. 4 is a block diagram illustrating exemplary processing engine according to some embodiments of the present disclosure;

FIG. 5 is a flowchart illustrating an exemplary process for identifying a false breakdown report for a vehicle according to some embodiments of the present disclosure; and

FIG. 6 is a flowchart illustrating an exemplary process for identifying a damaged vehicle according to some embodiments of the present disclosure.

### DETAILED DESCRIPTION

In the following detailed description, numerous specific details are set forth by way of examples in order to provide a thorough understanding of the relevant disclosure. However, it should be apparent to those skilled in the art that the present disclosure may be practiced without such details. In other instances, well-known methods, procedures, systems, components, and/or circuitry have been described at a relatively high-level, without detail, in order to avoid unnecessarily obscuring aspects of the present disclosure. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

It will be understood that the term “system,” “engine,” “unit,” “module,” and/or “block” used herein are one method to distinguish different components, elements, parts, section or assembly of different level in descending order. However, the terms may be displaced by another expression if they achieve the same purpose.

Generally, the word “module,” “unit,” or “block,” as used herein, refers to logic embodied in hardware or firmware, or to a collection of software instructions. A module, a unit, or a block described herein may be implemented as software and/or hardware and may be stored in any type of non-transitory computer-readable medium or other storage device. In some embodiments, a software module/unit/block may be compiled and linked into an executable program. It will be appreciated that software modules can be callable from other modules/units/blocks or from themselves, and/or may be invoked in response to detected events or interrupts. Software modules/units/blocks configured for execution on computing devices may be provided on a computer-readable medium, such as a compact disc, a digital video disc, a flash drive, a magnetic disc, or any other tangible medium, or as a digital download (and can be originally stored in a compressed or installable format that needs installation, decompression, or decryption prior to execution). Such software code may be stored, partially or fully, on a storage device of the executing computing device, for execution by the computing device. Software instructions may be embedded in a firmware, such as an erasable programmable read-only memory (EPROM). It will be further appreciated that hardware modules/units/blocks may be included in connected logic components, such as gates and flip-flops, and/or can be included of programmable units, such as programmable gate arrays or processors. The modules/units/blocks or computing device functionality described herein may be implemented as software modules/units/blocks, but may be represented in hardware or firmware. In general, the modules/units/blocks described herein refer to logical modules/units/blocks that may be combined with other modules/units/blocks or divided into sub-modules/sub-units/sub-blocks despite their physical organization or storage. The description may be applicable to a system, an engine, or a portion thereof.

It will be understood that when a unit, engine, module or block is referred to as being “on,” “connected to,” or “coupled to,” another unit, engine, module, or block, it may be directly on, connected or coupled to, or communicate with the other unit, engine, module, or block, or an intervening unit, engine, module, or block may be present, unless the context clearly indicates otherwise. As used herein, the term “and/or” includes any and all combinations of one or more of the associated listed items.

These and other features, and characteristics of the present disclosure, as well as the methods of operation and functions of the related elements of structure and the combination of parts and economies of manufacture, may become more apparent upon consideration of the following description with reference to the accompanying drawings, all of which form a part of this disclosure. It is to be expressly understood, however, that the drawings are for the purpose of illustration and description only and are not intended to limit the scope of the present disclosure. It is understood that the drawings are not to scale.

The flowcharts used in the present disclosure illustrate operations that systems implement according to some embodiments in the present disclosure. It is to be expressly understood, the operations of the flowchart may be implemented not in order. Conversely, the operations may be implemented in inverted order, or simultaneously. Moreover, one or more other operations may be added to the flowcharts. One or more operations may be removed from the flowcharts.

The system or method of the present disclosure may be applied to any kind of O2O services, such as on-demand services and/or sharing services. For example, the system or method of the present disclosure may be applied to transportation systems of different environments including land, ocean, aerospace, or the like, or any combination thereof. The vehicle used in the transportation systems may include a taxi, a private car, a hitch, a bus, a train, a bullet train, a high-speed rail, a subway, a vessel, an aircraft, a spaceship, a hot-air balloon, a driverless vehicle, a bicycle, a tricycle, a cart, a wheelchair, a unicycle, a tandem, a motor bicycle, an electric bicycle, a moped, a motor tricycle, an electric tricycle, or the like, or any combination thereof. In some embodiments, the vehicle of the present disclosure refers to a bicycle or electric bicycle. As another example, the service objects of the O2O on-demand or sharing services may be any other things, such as a safe box, a luggage, an umbrella, fitness equipment, or the like, or any combination thereof. The application of the system or method of the present disclosure may include a web page, a plug-in of a browser, a client terminal, a custom system, an internal analysis system, an artificial intelligence robot, or the like, or any combination thereof.

An aspect of the present disclosure provides systems and methods for a false breakdown report in an O2O service platform. After receiving a breakdown report of a vehicle from a service requester, the systems may determine whether the breakdown report is false based on a first prediction model and feature values of a plurality of first determining features associated with the vehicle and the service requester. In response to a determination that the breakdown report is true, the systems may provide a reward to the service requester. For example, the systems may transmit an electronic coupon for a free ride to the service requester. In response to a determination that the breakdown report is false, the systems may provide an alert to the service requester. For example, the systems may transmit electronic signals to a terminal of the service requester to direct the terminal to forbid the service requester to request the O2O service.

Another aspect of the present disclosure provides systems and methods for identifying a damaged vehicle in an O2O service platform. After receiving a request for checking a vehicle, the systems may determine whether the vehicle is damaged based on a second prediction model and feature values associated with the vehicle. The systems may also transmit electronic signals to an electronic device of a service requester or a maintenance worker. The electronic signal may direct the electronic device to display one or more messages related to whether the vehicle is damaged.

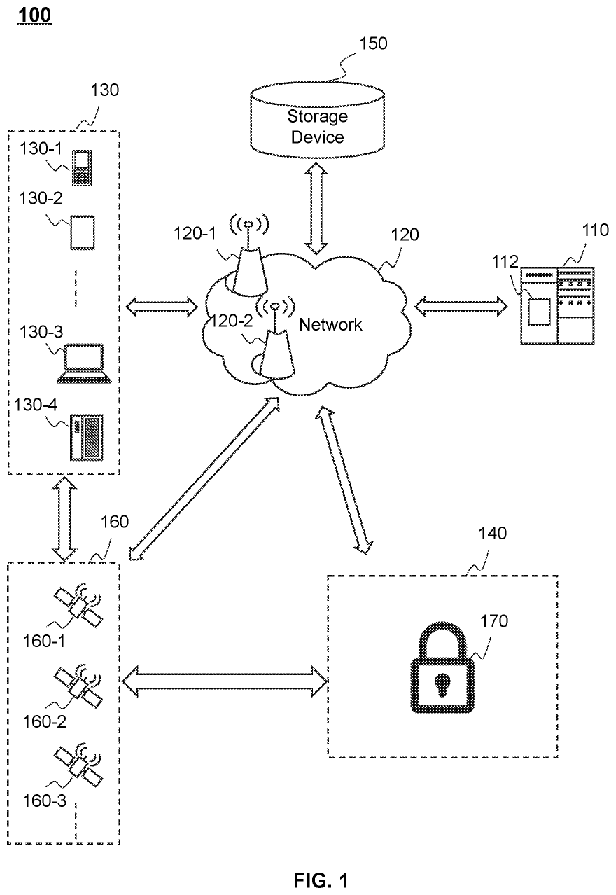

FIG. 1 is a schematic diagram illustrating an exemplary O2O service system according to some embodiments of the present disclosure. The O2O service system 100 may include a server 110, a network 120, one or more terminal devices 130, one or more service devices 140, a storage device 150, and a positioning device 160. The service device 140 may be secured by a lock 170. The O2O service system 100 may be an online to offline on-demand or sharing system for providing on-demand or sharing services.

In some embodiments, the server 110 may be a single server or a server group. The server group may be a centralized server group connected to the network 120 via an access point or a distributed server group connected to the network 120 via one or more access points, respectively. In some embodiments, the server 110 may be locally connected to the network 120 or in remote connection with the network 120. For example, the server 110 may access information and/or data stored in the terminal device 130, the service device 140, the storage device 150, and/or the lock 170 via the network 120. As another example, the storage device 150 may serve as backend data storage of the server 110. In some embodiments, the server 110 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the server 110 may include a processing engine 112. The processing engine 112 may process information and/or data related to performing one or more functions in the present disclosure. For example, the processing engine 112 may determine whether a breakdown report of the service device 140 (e.g., a bicycle) transmitted from the terminal device 130 is false. As another example, the processing engine 112 may identify whether the service device 140 is damaged. In some embodiments, the processing engine 112 may include one or more processing units (e.g., single-core processing engine(s) or multi-core processing engine(s)). Merely by way of example, the processing engine 112 may include a central processing unit (CPU), an application-specific integrated circuit (ASIC), an application-specific instruction-set processor (ASIP), a graphics processing unit (GPU), a physics processing unit (PPU), a digital signal processor (DSP), a field programmable gate array (FPGA), a programmable logic device (PLD), a controller, a microcontroller unit, a reduced instruction-set computer (RISC), a microprocessor, or the like, or any combination thereof.

The network 120 may facilitate exchange of information and/or data. In some embodiments, one or more components of the O2O service system 100 (e.g., the server 110, the terminal device 130, the service device 140, the storage device 150, or the lock 170) may transmit information and/or data to another component(s) in the O2O service system 100 via the network 120. For example, the server 110 may transmit a message indicating whether the service device 140 is damaged to the terminal device 130 via the network 120.

In some embodiments, the network 120 may be any type of wired or wireless network, or combination thereof. Merely by way of example, the network 120 may include a cable network, a wireline network, an optical fiber network, a telecommunications network, an intranet, an Internet, a local area network (LAN), a wide area network (WAN), a wireless local area network (WLAN), a metropolitan area network (MAN), a wide area network (WAN), a public telephone switched network (PSTN), a Bluetooth network, a ZigBee network, a near field communication (NFC) network, or the like, or any combination thereof. In some embodiments, the network 120 may include one or more network access points. For example, the network 120 may include wired or wireless network access points such as base stations and/or internet exchange points 120-1, 120-2, . . . , through which one or more components of the O2O service system 100 may be connected to the network 120 to exchange data and/or information.

In some embodiments, the terminal device 130 may include a mobile device 130-1, a tablet computer 130-2, a laptop computer 130-3, or the like, or any combination thereof. In some embodiments, the mobile device 130-1 may include a smart home device, a wearable device, a smart mobile device, a virtual reality device, an augmented reality device, or the like, or any combination thereof. In some embodiments, the smart home device may include a smart lighting device, a control device of an intelligent electrical apparatus, a smart monitoring device, a smart television, a smart video camera, an interphone, or the like, or any combination thereof. In some embodiments, the wearable device may include a smart bracelet, a smart footgear, smart glass, a smart helmet, a smartwatch, smart clothing, a smart backpack, a smart accessory, or the like, or any combination thereof. In some embodiments, the smart mobile device may include a smartphone, a personal digital assistant (PDA), a gaming device, a navigation device, a point of sale (POS) device, an artificial intelligence robot, or the like, or any combination thereof. In some embodiments, the virtual reality device and/or the augmented reality device may include a virtual reality helmet, a virtual reality glass, a virtual reality patch, an augmented reality helmet, an augmented reality glass, an augmented reality patch, or the like, or any combination thereof. For example, the virtual reality device and/or the augmented reality device may include a Google Glass™, an Oculus Rift™, a Hololens™, a Gear VR™, etc. In some embodiments, the terminal device 130 may include a signal transmitter and a signal receiver configured to communicate with the positioning device 160 for locating the position of the user and/or the terminal device 130. For example, the terminal device 130 may transmit an instruction to the positioning device 160 to locate the position of the user and/or the terminal device 130.

The service device 140 may be configured to be used in service in the O2O service system 100. The service device 140 may be any object. For example, the service device 140 may be a vehicle, such as a taxi, a private car, a hitch, a bus, a train, a bullet train, a high-speed rail, a subway, a vessel, an aircraft, a spaceship, a hot-air balloon, a driverless vehicle, a bicycle, a tricycle, a cart, a wheelchair, a unicycle, a tandem, a motor bicycle, an electric bicycle, a moped, a motor tricycle, an electric tricycle, etc. As another example, the service device 140 may be a safe box, a luggage, an umbrella, fitness equipment, etc.

The lock 170 may be configured to secure the service device 140. The lock 170 may include any one or a combination of mechanisms to implement the functions thereof. The lock 170 may be a mechanical lock, a smart lock, an electronic lock, or the like. The service device 140 and the lock 170 may be separate parts that are mechanically connected to each other. For example, the service device 140 and the lock 170 may be separate parts, and the lock 170 may be mounted on the service device 140. Additionally or alternatively, the service device 140 and the lock may form an integral device. The service device 140 and/or the lock 170 may be identified with a unique identifier (ID). The unique ID may include a barcode, a quick response (QR) code, a serial number including letters and/or digits, or the like, or any combination thereof.

In some embodiments, the service device 140 and/or the lock 170 may or may not communicate with one or more components (e.g., the server 110, the terminal device 130, and/or the positioning device 160) of the O2O service system 100. For example, the lock 170 may be a mechanical lock and not communicate with the one or more components of the O2O service system 100. As another example, the service device 140 and/or the lock 170 may include a global positioning system (GPS) component. The service device 140 and/or the lock 170 may communicate with the positioning device 160 for locating the position of The service device 140 and/or the lock 170, and transmit the positions of the lock 170 and/or the service device 140 to the server 110 in real-time via the network 120.

The storage device 150 may store data and/or instructions. In some embodiments, the storage device 150 may store data obtained from the terminal device 130, the server 110, the service device 140, or the lock 170. For example, the storage device 150 may store breakdown reports of the service device 140 obtained from the terminal device 130. In some embodiments, the storage device 150 may store data and/or instructions that the server 110 may execute or use to perform exemplary methods described in the present disclosure. For example, the storage device 150 may store data and/or instructions that the server 110 may execute or use to determine whether the service device 140 is damaged. In some embodiments, the storage device 150 may include a mass storage, removable storage, a volatile read-and-write memory, a read-only memory (ROM), or the like, or any combination thereof. Exemplary mass storage may include a magnetic disk, an optical disk, a solid-state drive, etc. Exemplary removable storage may include a flash drive, a floppy disk, an optical disk, a memory card, a zip disk, a magnetic tape, etc. Exemplary volatile read-and-write memory may include a random access memory (RAM). Exemplary RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. Exemplary ROM may include a mask ROM (MROM), a programmable ROM (PROM), an erasable programmable ROM (EPROM), an electrically erasable programmable ROM (EEPROM), a compact disk ROM (CD-ROM), and a digital versatile disk ROM, etc. In some embodiments, the storage device 150 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof. In some embodiments, the storage device 150 may be part of the server 110.

The positioning device 160 may determine information associated with an object, for example, one or more of the terminal devices 130, the lock 170, or the service device 140 (e.g., a bicycle). For example, the positioning device 160 may determine a current time and a current location of the terminal device 130, the lock 170, and/or the service device 140. In some embodiments, the positioning device 160 may be a global positioning system (GPS), a global navigation satellite system (GLONASS), a compass navigation system (COMPASS), a BeiDou navigation satellite system, a Galileo positioning system, a quasi-zenith satellite system (QZSS), etc. The information may include a location, an elevation, a velocity, or an acceleration of the object, and/or a current time. The location may be in the form of coordinates, such as a latitude coordinate and a longitude coordinate, etc. The positioning device 160 may include one or more satellites, for example, a satellite 160-1, a satellite 160-2, and a satellite 160-3. The satellite 160-1 through 160-3 may determine the information mentioned above independently or jointly. The positioning device 160 may transmit the information mentioned above to the terminal device 130, the lock 170, or the service device 140 via the network 120.

In some embodiments, one or more components of the O2O service system 100 may access the data and/or instructions stored in the storage device 150 via the network 120. In some embodiments, the storage device 150 may be directly connected to the server 110 as a backend storage. In some embodiments, one or more components of the O2O service system 100 (e.g., the server 110, the terminal device 130, or the service device 140) may have permissions to access the storage device 150. In some embodiments, one or more components of the O2O service system 100 may read and/or modify the information related to the user, and/or the service device 140 when one or more conditions are met. For example, the server 110 may read and/or modify one or more users' information after a ride of a bicycle is completed.

Merely by way of example, the service device 140 may be a bicycle. The O2O service system 100 may provide a bicycle sharing or on-demand bicycle rental service allowing a user to use a bicycle for a ride. The information exchange between one or more components of the O2O service system 100 may be initiated by way of launching an application of the O2O service system 100 on the terminal device 130, initiating a service request (also referred to as service order or order) for the bicycle sharing or on-demand bicycle rental service, or inputting a query via the terminal device 130 (e.g., searching for an available bicycle). For example, the terminal device 130 may obtain the unique ID of the service device 140 and/or the lock 170 (e.g., a service requester may input the unique ID through an interface of the application on the terminal device 130 or scan the unique ID through a camera of the terminal device 130), and transmit a service request including the unique ID to the server 100. Alternatively or additionally, the service request may also include a departure location, a destination, a departure time, or the like, or any combination thereof. The server 100 may transmit a message for unlocking the service device 140 to the terminal device 130, the service device 140, or the lock 170. For example, the server 100 may transmit a password to the terminal device 130. The service requester may unlock the service device 140 manually based on the password. As another example, the server 100 may transmit an unlocking instruction to the lock 170. The lock 170 may unlock the service device 140 automatically based on the unlocking instruction. After the service device 140 is unlocked, the service requester may operate the service device 140 for a ride. When the service requester finishes the ride and wants to return the service device 140, the user may leave the service device 140 in an area where the parking of the service device 140 is permitted and lock the service device 140 using the lock 170. The service requester may pay for operating the vehicle. The service device 140 may then be ready for a next user.

The service request of the O2O on-demand or sharing service may be a real-time service request or a reservation service request.

The real-time service request may be a service request that a service requester wishes to receive the O2O on-demand or sharing service (e.g., unlock the service device 140) at the present moment or at a defined time reasonably close to the present moment for an ordinary person in the art (e.g., 1 minute, 2 minutes, or 5 minutes after the present moment).

The reservation service request may refer to a service request that the service requester wishes to receive the O2O on-demand or sharing service (e.g., unlock the service device 140) at a time reasonably long from the present moment for the ordinary person in the art (e.g., 15 minutes, 30 minutes, 1 hour, 2 hours, or 1 day after the present moment).

One of ordinary skill in the art would understand that when an element of the O2O service system 100 performs, the element may perform through electrical signals and/or electromagnetic signals. For example, when the processing engine 112 processes a task, such as making a determination, or identifying information, the processing engine 112 may operate logic circuits in its processor to process such task. When the processing engine 112 receives data (e.g., a breakdown report of the service device 140) from the terminal device 130, a processor of the processing engine 112 may receive electrical signals encoding/including the data. The processor of the processing engine 112 may receive the electrical signals through one or more information exchange ports. If the terminal device 130 communicates with the processing engine 112 via a wired network, the information exchange port may be physically connected to a cable. If the terminal device 130 communicates with the processing engine 112 via a wireless network, the information exchange port of the processing engine 112 may be one or more antennas, which may convert the electrical signals to electromagnetic signals. Within an electronic device, such as the terminal device 130, and/or the server 110, when a processor thereof processes an instruction, sends out an instruction, and/or performs an action, the instruction and/or action is conducted via electrical signals. For example, when the processor retrieves or saves data from a storage medium (e.g., the storage device 150), it may send out electrical signals to a read/write device of the storage medium, which may read or write structured data in the storage medium. The structured data may be transmitted to the processor in the form of electrical signals via a bus of the electronic device. Here, an electrical signal may refer to one electrical signal, a series of electrical signals, and/or a plurality of discrete electrical signals.

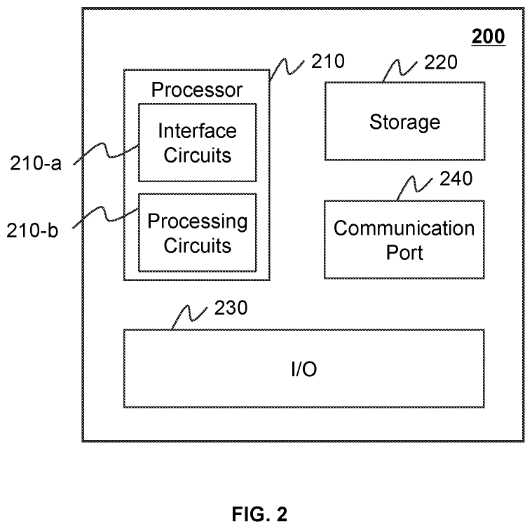

FIG. 2 is a schematic diagram illustrating exemplary hardware and/or software components of a computing device on which the processing engine 112 may be implemented according to some embodiments of the present disclosure. As illustrated in FIG. 2, the computing device 200 may include a processor 210, a storage 220, an input/output (I/O) 230, and a communication port 240.

The processor 210 (e.g., logic circuits) may execute computer instructions (e.g., program code) and perform functions of the processing engine 112 in accordance with techniques described herein. For example, the processor 210 may include interface circuits 210-a and processing circuits 210-b therein. The interface circuits may be configured to receive electronic signals from a bus (not shown in FIG. 2), wherein the electronic signals encode structured data and/or instructions for the processing circuits to process. The processing circuits may conduct logic calculations, and then determine a conclusion, a result, and/or an instruction encoded as electronic signals. Then the interface circuits may send out the electronic signals from the processing circuits via the bus.

The computer instructions may include, for example, routines, programs, objects, components, data structures, procedures, modules, and functions, which perform particular functions described herein. For example, the processor 210 may determine whether a breakdown report associated with the service device 140 (e.g., a bicycle) transmitted from the terminal device 130 is false. As another example, the processor 210 may identify whether the service device 140 (e.g., a bicycle) is damaged and determine damaged components of the service device 140 (e.g., a bicycle). In some embodiments, the processor 210 may include one or more hardware processors, such as a microcontroller, a microprocessor, a reduced instruction set computer (RISC), an application specific integrated circuits (ASICs), an application-specific instruction-set processor (ASIP), a central processing unit (CPU), a graphics processing unit (GPU), a physics processing unit (PPU), a microcontroller unit, a digital signal processor (DSP), a field programmable gate array (FPGA), an advanced RISC machine (ARM), a programmable logic device (PLD), any circuit or processor capable of executing one or more functions, or the like, or any combinations thereof.

Merely for illustration, only one processor is described in the computing device 200. However, it should be noted that the computing device 200 in the present disclosure may also include multiple processors, thus operations and/or method steps that are performed by one processor as described in the present disclosure may also be jointly or separately performed by the multiple processors. For example, if in the present disclosure the processor of the computing device 200 executes both step A and step B, it should be understood that step A and step B may also be performed by two or more different processors jointly or separately in the computing device 200 (e.g., a first processor executes step A and a second processor executes step B, or the first and second processors jointly execute steps A and B).

The storage 220 may store data/information obtained from the user terminal 140, the storage device 150, and/or any other component of the O2O service system 100. In some embodiments, the storage 220 may include a mass storage, a removable storage, a volatile read-and-write memory, a read-only memory (ROM), or the like, or any combination thereof. For example, the mass storage may include a magnetic disk, an optical disk, a solid-state drives, etc. The removable storage may include a flash drive, a floppy disk, an optical disk, a memory card, a zip disk, a magnetic tape, etc. The volatile read-and-write memory may include a random access memory (RAM). The RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. The ROM may include a mask ROM (MROM), a programmable ROM (PROM), an erasable programmable ROM (EPROM), an electrically erasable programmable ROM (EEPROM), a compact disk ROM (CD-ROM), and a digital versatile disk ROM, etc. In some embodiments, the storage 220 may store one or more programs and/or instructions to perform exemplary methods described in the present disclosure. For example, the storage 220 may store a program for the processing engine 112 for determining whether the service device 140 is damaged.

The I/O 230 may input and/or output signals, data, information, etc. In some embodiments, the I/O 230 may enable a user interaction with the processing engine 112. For example, a user of the O2O service system 100 may input a predetermined parameter through the I/O 230. In some embodiments, the I/O 230 may include an input device and an output device. Examples of the input device may include a keyboard, a mouse, a touch screen, a microphone, or the like, or a combination thereof. Examples of the output device may include a display device, a loudspeaker, a printer, a projector, or the like, or a combination thereof. Examples of the display device may include a liquid crystal display (LCD), a light-emitting diode (LED)-based display, a flat panel display, a curved screen, a television device, a cathode ray tube (CRT), a touch screen, or the like, or a combination thereof.

The communication port 240 may be connected to a network (e.g., the network 120) to facilitate data communications. The communication port 240 may establish connections between the processing engine 112 and the user terminal 140, the positioning system 160, or the storage device 150. The connection may be a wired connection, a wireless connection, any other communication connection that can enable data transmission and/or reception, and/or any combination of these connections. The wired connection may include, for example, an electrical cable, an optical cable, a telephone wire, or the like, or any combination thereof. The wireless connection may include, for example, a Bluetooth™ link, a Wi-Fi™ link, a WiMax™ link, a WLAN link, a ZigBee link, a mobile network link (e.g., 3G, 4G, 5G, etc.), or the like, or a combination thereof. In some embodiments, the communication port 240 may be and/or include a standardized communication port, such as RS232, RS485, etc.

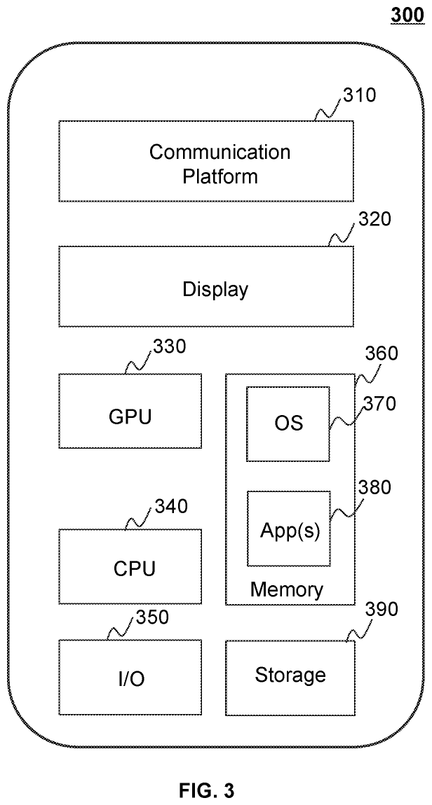

FIG. 3 is a schematic diagram illustrating exemplary hardware and/or software components of a mobile device on which the terminal device 130 may be implemented according to some embodiments of the present disclosure. As illustrated in FIG. 3, the mobile device 300 may include a communication platform 310, a display 320, a graphic processing unit (GPU) 330, a central processing unit (CPU) 340, an I/O 350, a memory 360, and a storage 390. In some embodiments, any other suitable component, including but not limited to a system bus or a controller (not shown), may also be included in the mobile device 300. In some embodiments, a mobile operating system 370 (e.g., iOS™, Android™, Windows Phone™, etc.) and one or more applications 380 may be loaded into the memory 360 from the storage 390 in order to be executed by the CPU 340. The applications 380 may include a browser or any other suitable mobile apps for receiving and rendering information relating to image processing or other information from the processing engine 112. User interactions with the information stream may be achieved via the I/O 350 and provided to the processing engine 112 and/or other components of the O2O service system 100 via the network 120.

To implement various modules, units, and their functionalities described in the present disclosure, computer hardware platforms may be used as the hardware platform(s) for one or more of the elements described herein. A computer with user interface elements may be used to implement a personal computer (PC) or any other type of work station or terminal device. A computer may also act as a server if appropriately programmed.

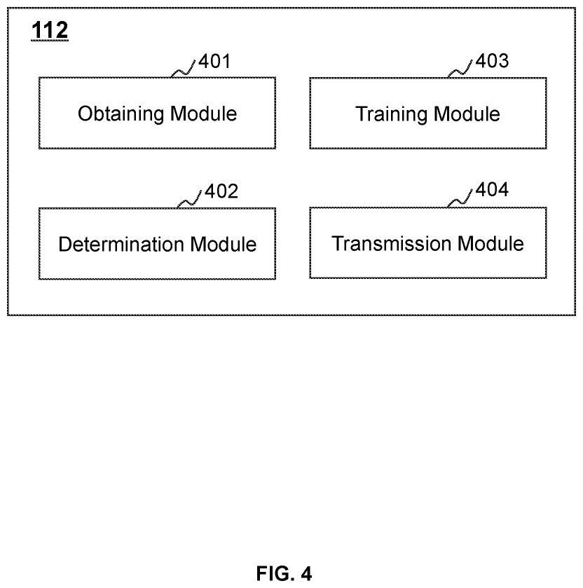

FIG. 4 is a block diagram illustrating exemplary processing engine according to some embodiments of the present disclosure. The processing engine 112 may include an obtaining module 401, a determination module 402, a training module 403, and a transmission module 404.

The obtaining module 401 may be configured to obtain information related to one or more components of the O2O service system 100. For example, the obtaining module 401 may receive a breakdown report for a vehicle from a service requester of the O2O service system 100. In some embodiments, the breakdown report for a vehicle may be produced via the terminal device 130 of the service requester. The breakdown report for a vehicle may include a unique ID of the vehicle, a location of the vehicle, a unique ID of the service requester, a name of a damaged component of the vehicle, a breakdown condition of the vehicle, a breakdown grade, or the like, or any combination thereof. In some embodiments, the obtaining module 401 may further obtain feature values of a plurality of first determining features associated with the service requester or the vehicle in response to the breakdown report. As another example, the obtaining module 401 may receive a request for checking a vehicle. In some embodiments, the obtaining module 401 may further obtain feature values of a plurality of second determining features associated with the vehicle in response to the request. The plurality of second determining features may include one or more features of the vehicle, one or more features of historical service orders of the vehicle, one or more features of maintenance of the vehicle, one or more features of historical breakdown reports of the vehicle, or the like, or any combination thereof.

The determination module 402 may be configured to determine whether the breakdown report is false and/or whether the vehicle is damaged. For example, the determination module 401 may determine whether the breakdown report is false based on a first prediction model and the feature values of the first determining features. In some embodiments, the feature values of the first determining features may be input to the first prediction model. The first prediction model may output a result relating to whether the breakdown report is false or true. As another example, the determination module 402 may determine whether the vehicle is damaged based on a second prediction model and the feature values of the second determining features. In some embodiments, the feature values of the second determining features may be input to the second prediction model. The second prediction model may output a result relating to whether the vehicle is damaged or not.

The training module 403 may be configured to generate the first prediction model and/or the second prediction model. For example, the training module 403 may generate the first prediction model by training a first preliminary model (e.g., an Extreme Gradient Boosting (XGBoost) model) using a plurality of training historical breakdown reports (e.g., labeled historical breakdown reports) relating to different users, vehicles, or service orders. For each training historical breakdown report, the training module 403 may obtain feature values of a plurality of first training features of the user, the vehicle, or the service order relating to the training historical breakdown report. In some embodiments, the training module 403 may mark the labeled true historical breakdown report as 1 and the labeled false historical breakdown report as 0. The training module 403 may input the feature values of the first training features and the marked training historical breakdown reports into the first preliminary model to train the first preliminary model and generate the first prediction model. In some embodiments, the training module 403 may test the accuracy of the first prediction model using a plurality of testing historical breakdown reports (e.g., labeled historical breakdown reports). As another example, the training module 403 may generate the second prediction model by training a second preliminary model using historical vehicle damage reports relating to training vehicles (e.g., labeled vehicles). For each training vehicle, the training module 403 may obtain feature values of a plurality of second training features of the training vehicle. In some embodiments, the training module 403 may mark the vehicle labeled as a damaged vehicle as 1 and the vehicle labeled as an undamaged vehicle as 0. The training module 403 may input the feature values of the second training features and the label results of the training vehicles into the second preliminary model to train the second preliminary model and generate the second prediction model. In some embodiments, the training module 403 may test the accuracy of the second prediction model using historical vehicle damage reports of testing vehicles (e.g., label vehicle).

The transmission module 404 may be configured to establish a connection between the processing engine 112 and one or more other components of the O2O service system 100. The connection may be a wired connection, a wireless connection, any other communication connection that can enable data transmission and/or reception, and/or any combination of these connections. For example, the transmission module 404 may transmit first electric signals to a mobile device (e.g., the terminal device 130) associated with the service requester. The first electric signals may direct the terminal device 130 to display one or more first messages related to whether the breakdown report is false. As another example, the transmission module 404 may transmit second electric signals to an electronic device. The second electric signals may direct the electronic device to display one or more second messages related to whether the vehicle is damaged. The electronic device may be associated with a service requester or a maintenance worker of the O2O service system 100.

The modules may be hardware circuits of all or part of the processing engine 112. The modules may also be implemented as an application or set of instructions read and executed by the processing engine 112. Further, the modules may be any combination of the hardware circuits and the application/instructions. For example, the modules may be the part of the processing engine 112 when the processing engine 112 executing the application/set of instructions.

It should be noted that the above description of the processing engine 112 is provided for the purposes of illustration, and is not intended to limit the scope of the present disclosure. For persons having ordinary skills in the art, multiple variations and modifications may be made under the teachings of the present disclosure. However, those variations and modifications do not depart from the scope of the present disclosure. In some embodiments, any module mentioned above may be implemented in two or more separate units. For example, the determination module 402 may be divided into two units, one of which is configured to determine whether a breakdown report for a vehicle is false, and the other of which is configured to determine whether a vehicle is damaged. In some embodiments, the processing engine 112 may further include one or more additional modules (e.g., a storage module).

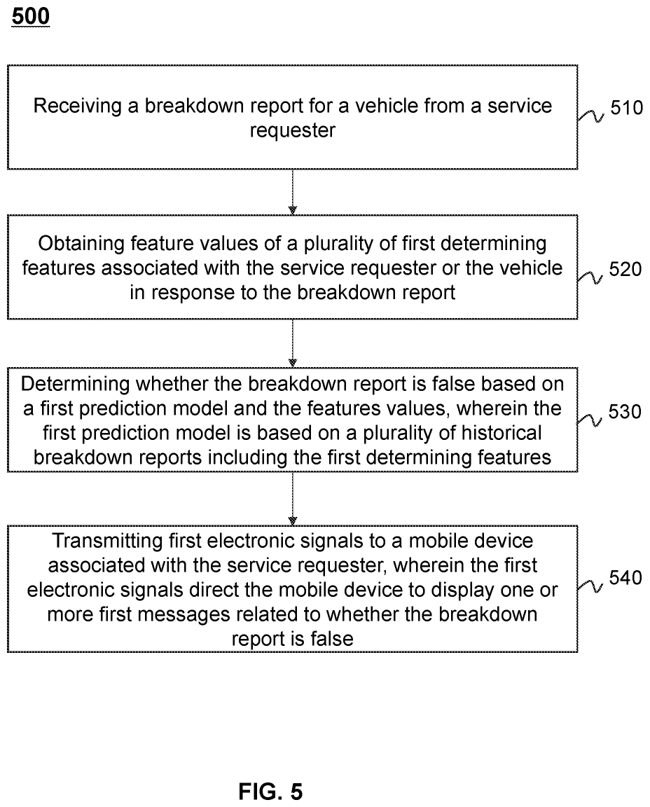

FIG. 5 is a flowchart illustrating an exemplary process for identifying a false breakdown report for a vehicle according to some embodiments of the present disclosure. At least a portion of process 500 may be implemented on the computing device 200 as illustrated in FIG. 2 or the mobile device 300 as illustrated in FIG. 3. In some embodiments, one or more operations of process 500 may be implemented in the O2O service system 100 as illustrated in FIG. 1. In some embodiments, one or more operations in the process 500 may be stored in a storage medium (e.g., the storage device 150, the storage 220, the storage 390.) as a form of instructions, and invoked and/or executed by the server 110 (e.g., the processing engine 112 in the server 110, the processor 210 of the computing device 200, or one or more modules in the processing engine 112 illustrated in FIG. 4). In some embodiments, the instructions may be transmitted in a form of electronic current or electrical signals. The operations of the illustrated process 500 presented below are intended to be illustrative. In some embodiments, the process 500 may be accomplished with one or more additional operations not described, and/or without one or more of the operations discussed. Additionally, the order in which the operations of the process 500 as illustrated in FIG. 5 and described below is not intended to be limiting.

For brevity, the description of the process 500 may take vehicle sharing or rental (e.g., the service device 140 is a vehicle) as an example. It should be noted that the vehicle sharing or rental described below is merely an example or implementation. For persons having ordinary skills in the art, the process 500 may be applied to other similar situations, such as safe box sharing/rental, umbrella sharing/rental, etc. In some embodiments, the vehicle can be bicycle or electric bicycle.

In 510, the obtaining module 401 (or the processing engine 112, and/or the interface circuits 210-a) may receive a breakdown report for the service device 140 (e.g., a vehicle) from a service requester (e.g., the terminal device 130 of the service requester) of the O2O service system 100. In some embodiments, the vehicle may include a taxi, a private car, a hitch, a bus, a train, a bullet train, a high-speed rail, a subway, a vessel, an aircraft, a spaceship, a hot-air balloon, a driverless vehicle, a bicycle, a tricycle, a cart, a wheelchair, a unicycle, a tandem, a motor bicycle, an electric bicycle, a moped, a motor tricycle, an electric tricycle, or the like, or any combination thereof.

In some embodiments, the breakdown report for a vehicle may be produced via the terminal device 130 of the service requester. For example, the service requester may input text, voice, pictures, videos, or the like, or any combination thereof through an interface of the application installed in the terminal device 130 to generate the breakdown report. The terminal device 130 may transmit the breakdown report to the processing engine 112 via the network 120.

The breakdown report for a vehicle may include a unique ID of the vehicle, a location of the vehicle, a unique ID of the service requester, a name of a damaged component of the vehicle, a breakdown condition of the vehicle, a breakdown grade, or the like, or any combination thereof.

Taking a bicycle as an example, the damaged component of the bicycle may include wheels, a chain, a brake (e.g., a rear brake or a front brake), a lock (e.g., the lock 170), a QR code, a handlebar, pedals, a saddle, a foot brace, a bell, a reflector, a basket, a mudguard, or the like, or any combination thereof. The breakdown condition of the vehicle may be detailed description of the damaged component. The breakdown condition of the vehicle may be in text, voice, images, videos, or the like, or any combination thereof. For example, the user may take one or more images of the vehicle using the terminal device 130 to describe the breakdown condition of the vehicle. As another example, the user may select one or more templates in the terminal device 130 to describe the breakdown condition of the vehicle.

In some embodiments, a breakdown grade may be used to estimate the level of damage to the vehicle. The breakdown grade may be defined by the O2O service system 100. For example, the breakdown grade may include a minor breakdown, a moderate breakdown, and a severe breakdown. The minor breakdown may refer to a breakdown that does not result in the vehicle losing one or more of its functions. For example, slight deformation of the basket of a bicycle and the lack of a handlebar grip may be minor breakdowns. The moderate breakdown may refer to a breakdown that results in the vehicle losing one or more functions but with which the vehicle still can be used for its basic purposes (e.g. facilitate traveling for one point to another). For example, a breakdown that the bell or a brake (e.g., a rear brake or a front brake of the bicycle) does not work may be moderate breakdowns. The severe breakdown may refer to a breakdown with which the vehicle cannot be used, even for its basic functions. For example, the lack of a wheel or a saddle of the bicycle and a breakdown that the chain of the bicycle is off may be the severe breakdown. In some embodiments, the application may display the definition of the breakdown grade and/or exemplary breakdowns that belong to the minor breakdown, the moderate breakdown, and the severe breakdown, respectively. The user may determine the breakdown grade of the breakdown she/he wants to report based on the displayed definition and/or exemplary breakdowns.

In some embodiments, the service requester may transmit the breakdown report of the vehicle to the processing engine 112 when the service requester tries to operate the vehicle. For example, if the service requester wants to operate the vehicle and finds that the vehicle is damaged before the service requester sends out a service request for operating the vehicle (e.g., before the vehicle is unlocked), the service requester may create a breakdown report of the vehicle and transmit the breakdown report of the vehicle to the processing engine 112. As another example, during the process of operating the vehicle, if the service requester finds that the vehicle is damaged, the service requester may create a breakdown report of the vehicle and transmit the breakdown report of the vehicle to the processing engine 112. As a further example, if the service requester finds that the vehicle is damaged after the service requester finishes operating the vehicle (e.g., after the service requester locks the vehicle), the service requester may create a breakdown report of the vehicle and transmit the breakdown report of the vehicle to the processing engine 112.

In 520, the obtaining module 401 (or the processing engine 112, and/or the interface circuits 210-a) may obtain feature values of a plurality of first determining features associated with the service requester or the vehicle in response to the breakdown report.

In some embodiments, the first determining feature associated with the service requester may include the total number of historical orders (e.g., including completed historical orders and canceled historical orders) of the O2O service system 100 that the service requester initiates, the number of the completed historical orders, the number of the canceled historical orders, a ratio of the number of the completed historical orders to the total number of the historical orders, a ratio of the number of the canceled historical orders to the total number of the historical orders, the total number of historical breakdown reports (e.g., including true historical breakdown reports and false historical breakdown reports) sent by the service requester, the number of true historical breakdown reports (reports that have been verified), the number of false historical breakdown reports (reports that have been proven false, e.g., by later inspections), a ratio of the number of true historical breakdown reports to the total number of historical breakdown reports, a ratio of the number of false historical breakdown reports to the total number of historical breakdown reports, the number of historical breakdown reports with one or more vehicle images, a ratio of the number of the historical breakdown reports with the one or more vehicle images to the total number of historical breakdown reports, a total mileage for operating vehicles of the O2O service system 100 of the service requester, a total time for operating vehicles of the O2O service system 100 of the service requester, whether there is at least one vehicle image in the breakdown report, whether the at least one vehicle image corresponds to the vehicle, whether the vehicle in the at least one vehicle image is damaged, the number of vehicle images in the breakdown report, the number of vehicle images corresponds to the vehicle, the number of vehicle images in which the vehicle is damaged, credit score of the service requester, a time interval between last historical breakdown report sent by the service requester and the current time, or the like, or any combination thereof.

In some embodiments, the first determining feature associated with the vehicle may include the total time for being operated by service requesters of the O2O service system 100, the number of times of being operated, the number of historical breakdown reports (e.g., including true historical breakdown reports and false historical breakdown reports) corresponding to the vehicle, the number of true historical breakdown reports corresponding to the vehicle, the number of false historical breakdown reports corresponding to the vehicle, a ratio of the number of true historical breakdown reports to the total number of historical breakdown reports corresponding to the vehicle, a ratio of the number of false historical breakdown reports to the total number of historical breakdown reports corresponding to the vehicle, an identifier (ID) of the vehicle, a total mileage of the vehicle, the number of the historical breakdown reports corresponding to the vehicle with one or more vehicle images, a ratio of the number of the historical breakdown reports with the one or more vehicle images to the total number of historical breakdown reports corresponding to the vehicle, the areas in which the vehicle is operated, a time when the vehicle is first put into use in the O2O service system 100, a total time that the vehicle is managed by the O2O service system 100, a city or region in which the vehicle is managed, a staff that manages the vehicle, the total number of times of maintenance of the vehicle, a time interval between last maintenance and the current time, a time interval between last historical breakdown report of the vehicle and the current time, or the like, or any combination thereof.

In some embodiments, the service requester may send the breakdown report to the processing engine 112 when he or she operates the vehicle based on a service order. In this case, the obtaining module 401 may also obtain feature values of first determining features associated with the service order. The first determining feature of the service order may include the duration that the service requester operates the vehicle based on the service order, the distance that the service requester operates the vehicle to travel based on the service order, the time when the service requester initiates the service order, a travel route in which the service requester operates the vehicle, or the like, or any combination thereof.

In some embodiments, the feature values of the first determining features may relate to a time period from a certain time point to the current time (e.g., the time when the obtaining module 401 receives the breakdown report). For example, the total mileage of the vehicle in the first determining features may refer to the total mileage of the vehicle from the time when the vehicle is first put into user in the O2O service system 100 to the current time.

In some embodiments, the feature value of the first determining feature may be a specific value of the first determining feature. For example, the feature value of the total number of the historical orders may be a specific value (e.g., 50, 100, 200, etc.) of the total number. As another example, the feature value of whether there is at least one vehicle image in the breakdown report may be 1 (e.g., representing that there is at least one vehicle image in the breakdown report) or 0 (e.g., representing that there is no vehicle image in the breakdown report).

In some embodiments, the obtaining module 401 may obtain the feature values of the first determining features from a storage medium (e.g., the storage device 150, or the storage 220 of the processing engine 112).

In some embodiments, the obtaining module 401 may determine whether the breakdown report includes one or more vehicle images by identifying one or more images in the breakdown report using, for example, image identification technologies. The obtaining module 401 may determine whether a vehicle image is corresponding to the vehicle. For example, the obtaining module 401 may identify the vehicle image and determine whether the unique ID of the vehicle is in the vehicle image. In response to a determination that the unique ID of the vehicle is in the vehicle image, the obtaining module 401 may determine that the vehicle image is corresponding to the vehicle. In response to a determination that the unique ID of the vehicle is not in the vehicle image, the obtaining module 401 may determine that the vehicle image is not corresponding to the vehicle.

In some embodiments, the presence of the vehicle image in the vehicle may or may not be determinant regarding whether the vehicle image corresponds to the vehicle, which can be decided by other factors such as but not limited to whether surrounding information in the image corresponds to the position of the reported vehicle. In some embodiments, when it is difficult or impossible to determine whether the vehicle image corresponds to the vehicle, a default setting (e.g. that there is correspondence) can be used.

In response to a determination that the vehicle image is corresponding to the vehicle, the obtaining module 401 may determine whether the vehicle in the vehicle image is damaged using, for example, a classification model. In some embodiments, the classification model may be provided by training a preliminary classification model using images with undamaged vehicles and images with damaged vehicles.

In 530, the determination module 402 (or the processing engine 112, and/or the processing circuits 210-b) may determine whether the breakdown report is false based on a first prediction model and the feature values of the first determining features.

In some embodiments, the feature values of the first determining features may be input to the first prediction model. The first prediction model may output a result relating to whether the breakdown report is false or true. In some embodiments, the first prediction model may output a probability that the breakdown report is true. The determination module 402 may determine whether the probability is greater than a first probability threshold (e.g., 50%, 60%, 70%, 80%, etc.). In response to a determination that the probability is greater than the first probability threshold, the determination module 402 may determine that the breakdown report is true. In response to a determination that the probability is less than or equal to the first probability threshold, the determination module 402 may determine that the breakdown report is false. The first probability threshold may be set by an operator or according to a default setting of the O2O service system 100.

In some embodiments, the determination module 402 may select different prediction models based on different types of the plurality of first determining features. For example, the prediction model for processing the plurality of first determining features relating to the breakdown report that includes at least one vehicle image and the prediction model for processing the plurality of first determining features relating to the breakdown report that includes no vehicle image may be different. In some embodiments, the determination module 402 may use one prediction model to process different types of the plurality of first determining features to determine whether the breakdown report is false.

In some embodiments, the classification model mentioned above may be same as or different from the first prediction model. For example, the classification model can be a part of the first prediction model.

In some embodiments, the first prediction model may be generated online or offline. In some embodiments, the first prediction model may be generated by the processing engine 112 (e.g., the training module 403) or a third-party device communicating with the O2O service system 100. In some embodiment, the training module 403 may generate the first prediction model in advance and store the first prediction model in a storage medium (e.g., the storage device 150, the storage 220 of the processing engine 112). When the obtaining module 401 receives the breakdown report, the determination module 402 may obtain the first prediction model from the storage medium. In some embodiments, when the obtaining module 401 receives the breakdown report, the training module 403 may generate the first prediction model online. In some embodiments, the third-party device may generate the first prediction model in advance and store the first prediction model locally or in the storage medium (e.g., the storage device 150, the storage 220 of the processing engine 112) of the O2O service system 100. When the obtaining module 401 receives the breakdown report, the determination module 402 may obtain the first prediction model from the storage medium of the O2O service system 100 or the third-party device. In some embodiments, when the obtaining module 401 receives the breakdown report, the third-party device may generate the first prediction model online and transmit the first prediction model to the determination module 402.

In some embodiments, after the processing engine 112 determines that a breakdown report for a vehicle is true, the processing engine 112 may assign a maintenance worker to repair the vehicle by, for example, transmitting a message including the breakdown report to a terminal of the maintenance worker. If the maintenance worker confirms that the vehicle is damaged, the breakdown report may be labeled as a confirmed true breakdown report. If the maintenance worker indicates that the vehicle is not damaged, the breakdown report may be labeled as a confirmed false breakdown report, indicating an error by the first prediction model. The label results of confirmed breakdown reports may be stored in a storage medium (e.g., the storage device 150, or the storage 220 of the processing engine 112) and used for training and/or updating the prediction models.

Merely by way of example, the training module 403 may generate the first prediction model by training a first preliminary model using a plurality of training historical breakdown reports (e.g., labeled historical breakdown reports) relating to different users, vehicles, or service orders. For each training historical breakdown report, the training module 403 may obtain feature values of a plurality of first training features of the user, the vehicle, or the service order relating to the training historical breakdown report. The first training features may be similar to the first determining features. In some embodiments, the first training features for each historical breakdown report may relate to a time period from a certain time point to the time when the obtaining module 401 received the historical breakdown report.

In some embodiments, the training module 403 may mark the labeled true historical breakdown report as 1 and the labeled false historical breakdown report as 0.

The first preliminary model may include a machine learning model such as a Gradient Boosting Decision Tree (GBDT) model or an Extreme Gradient Boosting (XGBoost) model. Taking a first preliminary model of XGBoost model as an example, the first preliminary model may include one or more first preliminary parameters, such as a booster type (e.g., tree-based model or linear model), a booster parameter (e.g., a maximum depth, a maximum number of leaf nodes), a learning task parameter (e.g., an objective function of training), or the like, or any combination thereof.

In some embodiments, the training module 403 may input the feature values of the first training features and the marked training historical breakdown reports into the first preliminary model to train the first preliminary model and generate the first prediction model.

In some embodiments, the training module 403 may test the accuracy of the first prediction model using a plurality of testing historical breakdown reports (e.g., labeled historical breakdown reports). The training module 403 may input feature values of first testing features of service requesters, vehicles, or service orders relating to the testing historical breakdown reports into the first prediction model to determine whether the testing historical breakdown reports are true or false. The first testing features may be similar to the first training features.

In some embodiments, if the accuracy of the first predication model is greater than or equal to a first accuracy threshold (e.g., 50%, 60%, 70%, 80%, 90%, etc.), the training module 403 may output a trained first prediction model, which can be used directly. If the accuracy of the first predication model is lower than the first accuracy threshold, the training module 403 may generate the first predication model based on a new preliminary model and/or new training features.

In some embodiments, the training historical breakdown reports may be different from the testing historical breakdown reports. A ratio of the number of the training historical breakdown reports to the number of the testing historical breakdown reports may be any value, such as but not limited to 7:3.

In some embodiments, the training module 403 may pre-process the first training features before training the first preliminary model in order to improve the accuracy of the first prediction model. The training module 403 may determine whether each feature value of the first training features is abnormal. In response to a determination that a feature value of a first training features is abnormal, the training module 403 may modify the abnormal feature value of the first training feature to a normal feature value. For example, the O2O service system 100 may have default setting that the number of historical orders that a service requester initiates in a year is from 500 to 1000. In certain embodiments, when the number of historical orders that a service requester initiates in a year is out of the range of 500 to 1000, the feature value of the number of historical orders may be determined to be abnormal. The training module 403 may modify the abnormal number of historical orders to be a value that is in the range of 500 to 1000 and is closest to the abnormal value. For example, if the number of historical orders is 1200, the training module 403 may modify the number of historical orders to be 1000. In some embodiments, the training module 403 may remove the abnormal feature values.

Alternatively or additionally, the training module 403 may pre-process the first testing features before testing the accuracy of the first predication model in order to improve the accuracy of the first prediction model. In some embodiments, the pre-processing of the first testing features may be similar to the first training features.

Alternatively or additionally, the determination module 402 may pre-process the first determining features before determining whether the breakdown report is true in order to improve the accuracy of the first prediction model. In some embodiments, the pre-processing of the first determining features may be similar to the first training features.

In some embodiments, the process for generating the first prediction model may also be performed by other devices, such as a third-party device communicating with the O2O service system 100.

In 540, the transmission module 404 (or the processing engine 112, and/or the interface circuits 210-a) may transmit first electric signals to a mobile device (e.g., the terminal device 130) associated with the service requester. The first electric signals may direct the terminal device 130 to display one or more first messages related to whether the breakdown report is false. The one or more first messages may be in any form, such as text, images, voice, videos, or the like, or a combination thereof.

In some embodiments, if the determination module 402 determines that the breakdown report is true, the O2O service system 100 may provide a reward to the service requester. For example, the transmission module 404 may transmit the first electric signals to the terminal device 130 of the service requester to direct the terminal device 130 to display the one or more first messages including one or more electronic coupons. As another example, the O2O service system 100 may increase the credit score of the service requester. If the credit score of the service requester is greater than a first score threshold (e.g., 80% of maximum), the O2O service system 100 may transmit one or more electronic coupons to the service requester. The one or more electronic coupons may include a coupon for a free order, a coupon for a discount (e.g., a 20% or a 50% discount coupon), a cash coupon, etc. The one or more electronic coupons may have a time limit for use or be permanently available. For example, when the service requester transmits a breakdown report for a vehicle during he or she operates the vehicle based on a service order, if the determination module 402 determines that the breakdown report is true, the transmission module 404 may transmit an electronic coupon for a free order available for the current service order. As another example, when the service requester transmits a breakdown report for a vehicle, if the determination module 402 determines that the breakdown report is true, the transmission module 404 may transmit an electronic coupon for a 50% discount available in the following three months from the current time. If the determination module 402 determines that the breakdown report is false, the O2O service system 100 may provide an alert to the service requester. For example, the transmission module 404 may transmit the first electric signals to the terminal device 130 of the service requester to direct the terminal device 130 to forbid the service requester to operate any vehicles of the O2O service system 100 for a certain number of times (e.g., 5 times) and/or for a time period (e.g., the following one month from the current time), and/or decrease the credit score of the user. If the credit score of the service requester is lower than a second score threshold (e.g., 10), the O2O service system 100 may forbid the service requester to operate any vehicles of the O2O service system 100 for a certain number of times (e.g., 5 times) and/or for a time period (e.g., the following one month from the current time).

In some embodiments, if the breakdown report is determined to be false, the first message may also include an inquiry for asking whether the service requester agrees that the breakdown report is false. The processing engine 112 may wait for a user response to the inquiry for a time period (e.g., 5 minutes). If the processing engine 112 receives a user response of disagreeing that the breakdown report is false from the terminal device 130 of the service requester in the time period, the processing engine 112 may assign a maintenance worker to confirm the report by, for example, transmitting a message including the breakdown report to a terminal associated with the maintenance worker. In some embodiments, the processing engine 112 does not provide any reward or alert to the service requester until the maintenance worker confirms whether the breakdown report is true. If the maintenance worker confirms that the breakdown report is true (e.g., the vehicle is damaged), the processing engine 112 may provide a bigger reward to the service requester, bigger than, for example, the normal reward without the confirmation. If the maintenance worker indicates that the breakdown report is false (e.g., the vehicle is undamaged), the processing engine 112 may send an alert to the service requester.

It should be noted that the above description regarding the process 500 is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. In some embodiments, one or more operations may be omitted and/or added. For example, after operation 540, if the breakdown report is determined to be true, the processing engine 112 may transmit electronic signals to a mobile device associated with a maintenance worker who is responsible for the maintenance of the vehicle. The electronic signals may direct the mobile device of the maintenance worker to display one or more messages including the breakdown report.

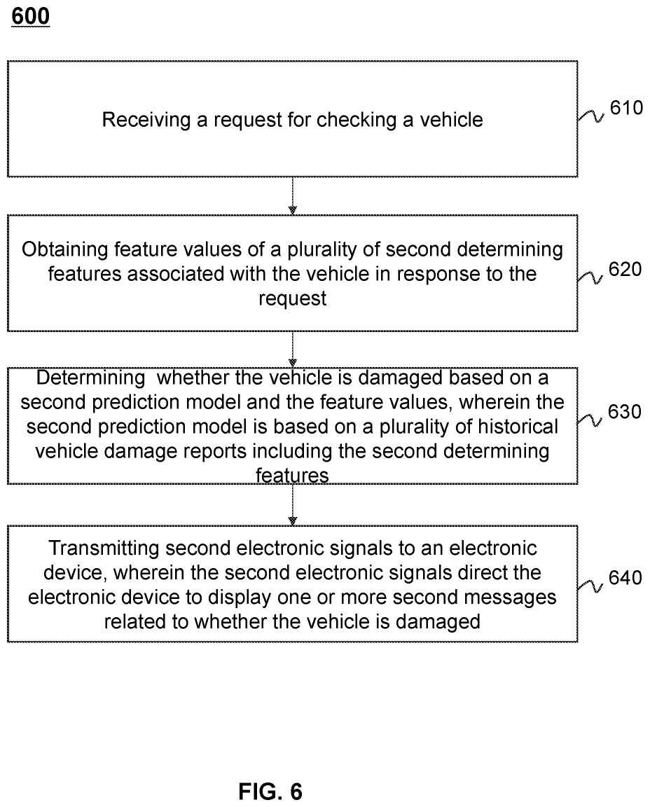

FIG. 6 is a flowchart illustrating an exemplary process for identifying a damaged vehicle according to some embodiments of the present disclosure. At least a portion of process 600 may be implemented on the computing device 200 as illustrated in FIG. 2 or the mobile device 300 as illustrated in FIG. 3. In some embodiments, one or more operations of process 600 may be implemented in the O2O service system 100 as illustrated in FIG. 1. In some embodiments, one or more operations in the process 600 may be stored in a storage device (e.g., the storage device 150, the storage 220, the storage 390.) as a form of instructions, and invoked and/or executed by the server 110 (e.g., the processing engine 112 in the server 110, or the processor 210 of the computing device 200). In some embodiments, the instructions may be transmitted in a form of electronic current or electrical signals. The operations of the illustrated process 600 presented below are intended to be illustrative. In some embodiments, the process 600 may be accomplished with one or more additional operations not described, and/or without one or more of the operations discussed. Additionally, the order in which the operations of the process 600 as illustrated in FIG. 6 and described below is not intended to be limiting.

For brevity, the description of the process 600 may take vehicle sharing or rental (e.g., the service device 140 is a vehicle) as an example. It should be noted that the vehicle sharing or rental described below is merely an example or implementation. For persons having ordinary skills in the art, the process 600 may be applied to other similar situations, such as but not limited to safe box sharing/rental, umbrella sharing/rental, etc.

In 610, the obtaining module 401 (or the processing engine 112, and/or the interface circuits 210-a) may receive a request for checking a vehicle.

In some embodiments, when a service requester transmits, to the processing engine 112, a service order for operating a vehicle (e.g., a request for opening a lock (e.g., the lock 170) of a vehicle) through a terminal (e.g., the terminal device 130) relating to the service requester, the terminal device 130 may also transmit the request for checking the vehicle to the processing engine 112. For example, when a service requester scans a QR code of a vehicle using the terminal device 130, the terminal device 130 may transmit a request for opening a lock of the vehicle and a request for checking the vehicle to the processing engine 112.

In some embodiments, when a service requester intends to initiate a service order of the O2O service system 100, the request for checking vehicles may be transmitted by the terminal device 130 of the service requester. For example, when the service requester opens the application of the O2O service system 100 on the terminal device 130, the application may direct the terminal device 130 to transmit a request for checking a vehicle closest to the terminal device 130 (also the service requester), or a request for checking one or more vehicles within a predetermined distance (e.g., 1 km) away from the terminal device 130 (also the service requester). As another example, when the service requester inputs at least a part of a departure location, the application may direct the terminal device 130 to transmit a request for checking a vehicle closest to the departure location, or a request for checking one or more vehicles within a predetermined distance (e.g., 1 km) from the departure location. As still another example, when the service requester inputs at least a part of information (e.g., the unique ID, the position, etc.) related to a vehicle, the application may direct the terminal device 130 to transmit a request for checking the vehicle.

In some embodiments, the O2O service system 100 may transmit the request for checking vehicles managed by the O2O service system 100 to the obtaining module 401 periodically (e.g., once per day, or once per week).

In some embodiments, a service requester may initiate a reservation service order including a departure location and a departure time. Before a predetermined time period (e.g., 5 minutes) from the departure time, the application may direct the terminal device 130 to transmit a request for checking a vehicle closest to the departure location, or a request for checking one or more vehicles within a predetermined distance (e.g., 1 km) from the departure location.

In some embodiments, when the processing engine 112 determines that a breakdown report of a vehicle is a true breakdown report based on, for example, operations 510-530 of the process 500, the processing engine 112 may transmit a request for checking the vehicle.

In 620, the obtaining module 401 (or the processing engine 112, and/or the interface circuits 210-a) may obtain feature values of a plurality of second determining features associated with the vehicle in response to the request.

The plurality of second determining features may include one or more features of the vehicle, one or more features of historical service orders of the vehicle, one or more features of maintenance of the vehicle, one or more features of historical breakdown reports of the vehicle, or the like, or any combination thereof.

In some embodiments, the features of the vehicle may include a time when the vehicle is first put into use in the O2O service system 100, a total time that the vehicle is managed by the O2O service system 100, a city or region in which the vehicle is managed, a staff that manages the vehicle, the number of times that the vehicle is determined to be damaged by the processing engine 112, the number of times that the vehicle is determined to be undamaged by the processing engine 112, or the like, or any combination thereof.

In some embodiments, the features of historical orders of the vehicle may include the total number of historical orders for requesting to operate the vehicle, the number of completed historical orders, the number of canceled historical orders, a ratio of the number of completed historical orders to the total number of historical orders, a ratio of the number of canceled historical orders to the total number of historical orders, a total mileage of the vehicle based on the historical orders, a total time for being operated by service requesters based on the historical orders, a region in which the vehicle is operated by service requesters based on the historical orders, a total income by operating the vehicle based on the historical orders, a mileage of the vehicle based on a last completed historical order, or the like, or any combination thereof.

In some embodiments, the features of maintenance of the vehicle may include the total number of times of maintenance of the vehicle, the number of times that the vehicle is determined to be undamaged after maintenance, the number of times that the vehicle is determined to be damaged after maintenance, a time interval between last maintenance and the current time, or the like, or any combination thereof.

In some embodiments, the features of historical breakdown reports of the vehicle may include the total number of historical breakdown reports of the vehicle, the number of false historical breakdown reports of the vehicle, the number of true historical breakdown reports of the vehicle, a ratio of the number of false historical breakdown reports to the total number of historical breakdown reports of the vehicle, a ratio of the number of true historical breakdown reports to the total number of historical breakdown reports of the vehicle, credit scores of service requesters that transmit the historical breakdown reports of the vehicle, a time interval between last historical breakdown report of the vehicle and the current time, or the like, or any combination thereof.

In some embodiments, the second determining features may relate to a time period from a certain time point to the current time (e.g., the time when the obtaining module 401 receives the request for checking the vehicle). For example, the total mileage of the vehicle in the second determining features may refer to the total mileage of the vehicle from the time when the vehicle is first put into use in the O2O service system 100 to the current time.

In some embodiments, the feature value of the second determining feature may be a specific value of the second determining feature. For example, the feature value of the total number of the historical orders may be a specific value (e.g., 50, 100, 200, etc.) of the total number. As another example, the feature value of the city or region in which the vehicle is managed may be a sequence number of the city or region. As still another example, the feature value of the staff that manages the vehicle may be an identifier including a set of numbers.

In some embodiments, the obtaining module 401 may obtain the feature values of the second determining features from a storage medium (e.g., the storage device 150, or the storage 220 of the processing engine 112).

In 630, the determination module 402 (or the processing engine 112, and/or the processing circuits 210-b) may determine whether the vehicle is damaged based on a second prediction model and the feature values of the second determining features.

In some embodiments, the feature values of the second determining features may be input to the second prediction model. The second prediction model may output a result relating to whether the vehicle is damaged or not. In some embodiments, the second prediction model may output a probability that the vehicle is damaged. The determination module 402 may determine whether the probability is greater than a second probability threshold (e.g., 50%, 60%, 70%, 80%, etc.). In response to a determination that the probability is greater than the second probability threshold, the determination module 402 may determine that the vehicle is damaged. In response to a determination that the probability is less than or equal to the second probability threshold, the determination module 402 may determine that the vehicle is undamaged. The second probability threshold may be set by an operator or according to a default setting of the O2O service system 100.

In response to a determination that the vehicle is damaged, the second prediction model may also output the breakdown grade and/or indicators (e.g. part names) of one or more damaged components of the vehicle based on the feature values of the second determining features.

Alternatively or additionally, in response to a determination that the vehicle is damaged, the determination module 402 may further determine the breakdown grade and/or one or more damaged components of the vehicle based on the historical breakdown reports of the vehicle. In some embodiments, the determination module 402 may obtain the historical breakdown reports of the vehicle transmitted to the processing engine 112 in a recent period (e.g., last 5 days, last 30 days, etc.). The determination module 402 may select the true historical breakdown reports (e.g., the labeled true historical breakdown reports and/or the determined true historical breakdown reports). In some embodiments, the details of determining whether a breakdown report is true may be found elsewhere of the present disclosure, e.g., in operations 520-530 and the descriptions thereof. The determination module 402 may determine the breakdown grade and/or the one or more damaged components of the vehicle based on the true historical breakdown reports. For example, in the 5 true historical breakdown reports of the vehicle, the moderate breakdown is mentioned for 3 times, the minor breakdown is mentioned for 2 times, and the severe breakdown is mentioned for 0 times, the determination module 402 may determine the breakdown grade of the vehicle to be the moderate breakdown. As another example, in the 5 true historical breakdown reports of the vehicle, the breakdown of the bell is mentioned for 4 times, and the breakdown of the brake is mentioned for 1 time, the determination module 402 may determine the damaged component of the vehicle to be the bell.

In some embodiments, the second prediction model may be generated online or offline. In some embodiments, the second prediction model may be generated by the processing engine 112 (e.g., the training module 403) or a third-party device communicating with the O2O service system 100. In some embodiment, the training module 403 may generate the second t prediction model in advance and store the second prediction model in a storage medium (e.g., the storage device 150, the storage 220 of the processing engine 112). When the obtaining module 401 receives the request for checking the vehicle, the determination module 402 may obtain the second prediction model from the storage medium. In some embodiments, when the obtaining module 401 receives the request for checking the vehicle, the training module 403 may generate the second prediction model online. In some embodiments, the third-party device may generate the second prediction model in advance and store the second prediction model locally or in the storage medium (e.g., the storage device 150, the storage 220 of the processing engine 112) of the O2O service system 100. When the obtaining module 401 receives the request for checking the vehicle, the determination module 402 may obtain the second prediction model from the storage medium of the O2O service system 100 or the third-party device. In some embodiments, when the obtaining module 401 receives the request for checking the vehicle, the third-party device may generate the second prediction model online and transmit the second prediction model to the determination module 402.

In some embodiments, after the maintenance of a vehicle, a vehicle damage report may be created and stored in a storage medium (e.g., the storage device 150, or the storage 220 of the processing engine 112). If the maintenance worker indicates that the vehicle is undamaged, the vehicle may be labeled as an undamaged vehicle with the maintenance time. If the maintenance worker confirms that the vehicle is damaged, the vehicle may be labeled as a damaged vehicle with the maintenance time.

Merely by way of example, the training module 403 may generate the second prediction model by training a second preliminary model using historical vehicle damage reports relating to training vehicles (e.g., labeled vehicles). For each training vehicle, the training module 403 may obtain feature values of a plurality of second training features of the training vehicle. The second training features may be similar to the second determining features. In some embodiments, the second training features for each training vehicle may relate to a time period from a certain time point to the maintenance time of the training vehicle. The historical vehicle damage reports may include the feature values of the second training features.

In some embodiments, the training module 403 may mark the vehicle labeled as a damaged vehicle as 1 and the vehicle labeled as an undamaged vehicle as 0.

The second preliminary model may include a machine learning model such as a Gradient Boosting Decision Tree (GBDT) model or an Extreme Gradient Boosting (XGBoost) model. Taking a second preliminary model of XGBoost model as an example, the second preliminary model may include one or more second preliminary parameters, such as a booster type (e.g., tree-based model or linear model), a booster parameter (e.g., a maximum depth, a maximum number of leaf nodes), a learning task parameter (e.g., an objective function of training), or the like, or any combination thereof.

The training module 403 may input the feature values of the second training features and the label results of the training vehicles into the second preliminary model to train the second preliminary model and generate the second prediction model.

The training module 403 may test the accuracy of the second prediction model using historical vehicle damage reports of testing vehicles (e.g., label vehicle). The training module 403 may input feature values of second testing features of the testing vehicles into the second prediction model to determine whether the testing vehicles are damaged or not. The second testing features may be similar to the second training features. If the accuracy of the second predication model is greater than or equal to a second accuracy threshold (e.g., 50%, 60%, 70%, 80%, 90%, etc.), the training module 403 may output a trained second prediction model, which can be used directly. If the accuracy of the second predication model is lower than the second accuracy threshold, the training module 403 may generate the second predication model based on a new preliminary model and/or new training features. The historical vehicle damage reports may include the feature values of the second testing features.

In some embodiments, the training vehicles may be different from the testing vehicles. A ratio of the number of the training vehicles to the number of the testing vehicles may be any value, such as but not limited to 7:3.

In some embodiments, the training module 403 may pre-process the second training features before training the second preliminary model in order to improve the accuracy of the second prediction model. Alternatively or additionally, the training module 403 may pre-process the second testing features before testing the accuracy of the second predication model in order to improve the accuracy of the second prediction model. Alternatively or additionally, the determination module 402 may pre-process the second determining features before determining whether the vehicle is damaged in order to improve the accuracy of the second prediction model. The pre-processing of the second training features, the second testing features, or the second determining features may be similar to that of the first training features described in operation 530 of the process 500.

In some embodiments, the process for generating the second prediction model may also be performed by other devices, such as a third-party device communicating with the O2O service system 100.

In some embodiments, the processing engine 112 may determine whether two or more vehicles are damaged by repeating operations 620-630.

In 640, the transmission module 404 (or the processing engine 112, and/or the interface circuits 210-a) may transmit second electric signals to an electronic device. The second electric signals may direct the electronic device to display one or more second messages related to whether the vehicle is damaged. The one or more second messages may be in any form, such as text, images, voice, videos, or the like, or a combination thereof. The electronic device may be associated with a service requester or a maintenance worker of the O2O service system 100.

In some embodiments, the O2O service system 100 may transmit the request for checking vehicles managed by the O2O service system 100 to the obtaining module 401 periodically (e.g., once per day, or once per week). The processing engine 112 may determine whether the vehicles managed by the O2O service system 100 are damaged based on, e.g., operations 620-630. The processing engine 112 may transmit the second electronic signals to the terminal device 130 of one or more maintenance workers to direct the terminal device 130 to display the second message. The second message may include the locations of damaged vehicles, the unique IDs of damaged vehicles, the breakdown grades of damaged vehicles, the damaged components of damaged vehicles, or the like, or any combination thereof. With the second messages, the maintenance workers may check the vehicles that are determined to be damaged by the processing engine 112, instead of all vehicles of the O2O service system 100, which reduces the time cost, the human cost, and the efficiency of maintenance of the vehicles of the O2O service system 100.

In some embodiments, if a service requester scans a QR code of a vehicle using the terminal device 130, the terminal device 130 may transmit a request for opening a lock (e.g., the lock 170) of the vehicle and a request for checking the vehicle to the processing engine 112. The processing engine 112 may perform operations 610-620 to determine whether the vehicle is damaged. In response to a determination that the vehicle is undamaged, the processing engine 112 may transmit an instruction for opening the lock of the vehicle to the terminal device 130 and/or the vehicle (or the lock 170). In response to a determination that the vehicle is damaged, the processing engine 112 may transmit the second electric signals to the terminal device 130 to direct the terminal device 130 to display the second message indicating an alert that the vehicle is damaged, the breakdown grade of the vehicle, or the damaged component of the vehicle. The second message may also include an inquiry of whether to continue to unlock the vehicle. If the processing engine 112 receives a positive response from the service requester, the processing engine 112 may transmit an instruction for opening the lock of the vehicle to the terminal device 130 and/or the vehicle (or the lock 170). If the processing engine 112 receives a negative response from the service requester, the vehicle may not be unlocked.

In some embodiments, if a service requester intends to initiate an order by opening an application of the O2O service system 100 on the terminal device 130, the application may direct the terminal device 130 to transmit a request for checking one or more vehicles within a predetermined distance (e.g., 1 km) from the terminal device 130 (also the service requester). The processing engine 112 may determine whether the one or more vehicles are damaged based on operations 620-630. The processing engine 112 may transmit the second electronic signals to the terminal device 130 to direct the terminal device 130 to display the second message. The second message may include the location of the damaged vehicle and/or the undamaged vehicle, a symbol (e.g., in a form of text, images, voice, videos, colors, etc.) of the damaged vehicle and/or the undamaged vehicle, the breakdown grade of the damaged vehicle, the damaged component of the damaged vehicle, a recommended vehicle, one or more routes from the current location (or the departure location) of the service requester to the recommended vehicle, a distance from the current location (or the departure location) of the service requester to the recommended vehicle, a travel time from the current location (or the departure location) of the service requester to the recommended vehicle, or the like, or any combination thereof.

In some embodiments, a service requester may initiate a reservation service order including a departure location and a departure time. Before a predetermined time period (e.g., 5 minutes) from the departure time, the application may direct the terminal device 130 to transmit a request for checking a vehicle closest to the departure location, or a request for checking one or more vehicles within a predetermined distance (e.g., 1 km) from the departure location. The processing engine 112 may determine whether the one or more vehicles are damaged based on operations 620-630. The processing engine 112 may transmit the second electronic signals to the terminal device 130 to direct the terminal device 130 to display the second message. The second message may include the location of the damaged vehicle and/or the undamaged vehicle, a symbol (e.g., in a form of text, images, voice, videos, colors, etc.) of the damaged vehicle and/or the undamaged vehicle, the breakdown grade of the damaged vehicle, the damaged component of the damaged vehicle, a recommended vehicle, one or more routes from the departure location of the service requester to the recommended vehicle, a distance from the departure location of the service requester to the recommended vehicle, a travel time from the departure location of the service requester to the recommended vehicle, or the like, or any combination thereof. In some embodiments, the processing engine 112 may reserve the recommended vehicle for the service requester for a predetermined time period (e.g., 10 minutes).

In some embodiments, when the processing engine 112 determines that a breakdown report of a vehicle is a true breakdown report based on, for example, operations 510-530 of the process 500, the processing engine 112 may transmit a request for checking the vehicle. The processing engine 112 may determine whether the vehicle is damaged based on operations 620-630. In response to a determination that the vehicle is damaged, the processing engine 112 may transmit the second electronic signals to the terminal device 130 of a maintenance worker to direct the terminal device 130 to display the second message. The second message may include the location of the vehicle, the unique ID of the vehicle, the breakdown grade of the vehicle, the damaged component of the vehicle, or the like, or any combination thereof.

It should be noted that the above description of the process 600 is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment,” “one embodiment,” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “block,” “module,” “engine,” “unit,” “component,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB. NET, Python or the like, conventional procedural programming languages, such as the “C” programming language, Visual Basic, Fortran 1703, Perl, COBOL 1702, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a software as a service (SaaS).

Furthermore, the recited order of processing elements or sequences, or the use of numbers, letters, or other designations, therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software-only solution—e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

1. A system for identifying a false breakdown report for a vehicle in an online to offline service, comprising:
at least one storage medium including a set of instructions;
at least one processor in communication with the at least one storage medium, wherein when executing the set of instructions, the at least one processor is directed to cause the system to:
receive a breakdown report for a vehicle from a user;
obtain feature values of a plurality of determining features associated with the user or the vehicle in response to the breakdown report;
determine whether the breakdown report is false based on a prediction model and the features values, wherein the prediction model is based on a plurality of historical breakdown reports including the determining features; and
transmit electronic signals to a mobile device associated with the user, wherein the electronic signals direct the mobile device to display one or more messages related to whether the breakdown report is false.

2. The system of claim 1, wherein the breakdown report includes at least one vehicle image obtained by the user; and
to determine whether the breakdown report is false based on the prediction model and the feature values, the at least one processor is directed to cause the system to:
determine whether the vehicle image is corresponding to the vehicle;
in response to a determination that the vehicle image is corresponding to the vehicle, determine whether the vehicle in the vehicle image is damaged based on the prediction model; and
determine whether the breakdown report is false based on a determination associated with whether the vehicle in the vehicle image is damaged.

3. The system of claim 1, wherein the breakdown report is produced after the user tries to operate the vehicle, wherein the determining features includes at least one of
a time period the user operates the vehicle,
a distance the user travels using the vehicle,
a time point when the user starts to operate the vehicle,
a number of times the vehicle is operated,
a number of breakdown reports related to the vehicle,
a time when the vehicle is put into use,
information related to historical orders of the online to offline service,
information related to completed orders of the historical orders,
a total distance the user travels,
a total number of historical breakdown reports transmitted by the user,
a number of true breakdown reports of the historical breakdown reports, or
a ratio between the true breakdown reports and the historical breakdown reports.

4. The system of claim 1, wherein the vehicle is a bicycle.

5. The system of claim 1, wherein in response to a determination that the breakdown report is false, the electronic signals further direct the mobile device to forbid the user to operate any vehicles related to the online to offline service.

6. The system of claim 1, wherein in response to a determination that the breakdown report is true, the one or more messages further include one or more electronic coupons.

7. A method for identifying a false breakdown report for a vehicle in an online to offline service implemented on a computing device having one or more processors and one or more storage devices, the method comprising:
receiving a breakdown report for a vehicle from a user;
obtaining feature values of a plurality of determining features associated with the user or the vehicle in response to the breakdown report;
determining whether the breakdown report is false based on a prediction model and the features values, wherein the prediction model is based on a plurality of historical breakdown reports including the determining features; and
transmitting electronic signals to a mobile device associated with the user, wherein the electronic signals direct the mobile device to display one or more messages related to whether the breakdown report is false.

8. The method of claim 7, wherein the breakdown report includes at least one vehicle image obtained by the user; and
wherein the determining of whether the breakdown report is false based on the prediction model and the feature values includes:
determining whether the vehicle image is corresponding to the vehicle;
in response to a determination that the vehicle image is corresponding to the vehicle, determining whether the vehicle in the vehicle image is damaged based on the prediction model; and
determining whether the breakdown report is false based on a determination associated with whether the vehicle in the vehicle image is damaged.

9. The method of claim 7, wherein the breakdown report is produced after the user tries to operate the vehicle, wherein the determining features includes at least one of
a time period the user operates the vehicle,
a distance the user travels using the vehicle,
a time point when the user starts to operate the vehicle,
a number of times the vehicle is operated,
a number of breakdown reports related to the vehicle,
a time when the vehicle is put into use,
information related to historical orders of the online to offline service,
information related to completed orders of the historical orders,
a total distance the user travels,
a total number of historical breakdown reports transmitted by the user,
a number of true breakdown reports of the historical breakdown reports, or
a ratio between the true breakdown reports and the historical breakdown reports.

10. The method of claim 7, wherein the vehicle is a bicycle.

11. The method of claim 7, wherein in response to a determination that the breakdown report is false, the electronic signals further direct the mobile device to forbid the user to operate any vehicles related to the online to offline service.

12. The method of claim 7, wherein in response to a determination that the breakdown report is true, the one or more messages further include one or more electronic coupons.

13-19. (canceled)

20. A system for identifying a damaged vehicle, comprising:
at least one storage medium including a set of instructions;
at least one processor in communication with the at least one storage medium, wherein when executing the set of instructions, the at least one processor is directed to cause the system to:
receive a request for checking a vehicle;
obtain feature values of a plurality of first determining features associated with the vehicle in response to the request, wherein the first determining features associated with the vehicle include breakdown reports associated with the vehicle received from first users;
determine whether the vehicle is damaged based on a first prediction model and the feature values of the first determining features, wherein the first prediction model is based on a plurality of historical vehicle damage reports including the first determining features; and
transmit first electronic signals to an electronic device, directing the electronic device to display one or more first messages related to whether the vehicle is damaged, wherein in response to a determination that the vehicle is damaged, the at least one processor is further directed to cause the system to:
determine one or more damaged components of the vehicle based on the breakdown reports received from the first users; and
transmit second electronic signals to the electronic device, directing the electronic device to display one or more second messages indicating the one or more damaged components of the vehicle.

21. The system of claim 20, wherein to receive the request for checking the vehicle, the at least one processor is directed to cause the system to:
receive a request for opening a lock of the vehicle from second user; or
determine that a second user intends to initiate an order associated with an online to offline service, wherein the vehicle is within a predetermined distance from a location of the first user.

22. (canceled)

23. The system of claim 21, wherein the electronic device is associated with the second user or a maintenance worker.

24. (canceled)

25. The system of claim 20, wherein to receive the request for checking the vehicle, the at least one processor is directed to cause the system to:
receive a breakdown report for the vehicle from a second user; and
determine that the breakdown report is true.

26. The system of claim 25, wherein to determine that the breakdown report is true, the at least one processor is directed to cause the system to:
obtain feature values of a plurality of second determining features associated with the second user or the vehicle; and
determine whether the breakdown report received from the second user is true based on a second prediction model and the features values of the second determining features, wherein the second prediction model is based on a plurality of historical breakdown reports including the second determining features.

27. The system of claim 26, wherein the breakdown report includes at least one vehicle image obtained by the second user; and
to determine whether the breakdown report is true based on the second prediction model and the feature values of the second determining features, the at least one processor is directed to cause the system to:
determine whether the at least one vehicle image is corresponding to the vehicle;
in response to a determination that the at least one vehicle image is corresponding to the vehicle, determine whether the vehicle in the at least one vehicle image is damaged based on the second prediction model; and
determine whether the breakdown report is true based on a determination associated with whether the vehicle in the at least one vehicle image is damaged.

28. The system of claim 20, wherein the vehicle is a bicycle.

29-47. (canceled)

48. The system of claim 1, wherein the at least one processor is directed to cause the system further to:
in response to a determination that breakdown report is true, receive a request for checking a vehicle;
obtain feature values of a plurality of first determining features associated with the vehicle in response to the request;
determine whether the vehicle is damaged based on a first prediction model and the feature values of the first determining features, wherein the first prediction model is based on a plurality of historical vehicle damage reports including the first determining features; and
transmit first electronic signals to an electronic device, directing the electronic device to display one or more first messages related to whether the vehicle is damaged.
